(19) United States
(12) Patent Application Publication
(10) Pub. No.: US 2010/0002184 A1
(43) Pub. Date: Jan. 7, 2010

(54) METHOD OF MANUFACTURING A LIQUID CRYSTAL DISPLAY

(75) Inventors: Jong-Ho SON, Seoul (KR); Jun-Hee Na, Asan-si (KR); Su-Han Woo, Asan-si (KR)

Correspondence Address: H.C. PARK & ASSOCIATES, PLC, 8500 LEESBURG PIKE, SUITE 7500, VIENNA, VA, 22182, US

(73) Assignee: Samsung Electronics Co., Ltd., Suwon-si (KR)

(21) Appl. No.: 12/388,990

(22) Filed: Feb. 19, 2009

(30) Foreign Application Priority Data
Jul. 1, 2008 (KR) 10-2008-0063523

(51) Int. Cl. G02F 1/1337

(52) U.S. Cl. 349/187

(57) ABSTRACT

There is provided a method of manufacturing a liquid crystal display including forming a first display panel including a plurality of switching elements, forming a second display panel, and disposing a liquid crystal mixture including a liquid crystal material and an alignment assistant material between the first display panel and the second display panel. The first display panel, the second display panel, and the liquid crystal mixture form a liquid crystal panel assembly, and the alignment assistant material is cured by applying ultrasonic waves to the liquid crystal panel assembly.

### CROSS-REFERENCE TO RELATED APPLICATION

This application claims priority from and the benefit of Korean Patent Application No. 10-2008-0063523 filed on Jul. 1, 2008, which is hereby incorporated by reference for all purposes as if fully set forth herein.

### BACKGROUND OF THE INVENTION

1. Field of the Invention

The present invention relates to a method of manufacturing a liquid crystal display.

2. Discussion of the Background

The liquid crystal display, which is one of the most commonly used flat panel displays, includes a first display panel, a second display panel, and a liquid crystal layer interposed between the first and second display panels. An image is displayed by applying a voltage to both sides of the liquid crystal layer to determine the orientation of the liquid crystal layer and control the polarization of incident light.

Among the liquid crystal displays, a liquid crystal display of a vertical alignment mode in which liquid crystal molecules are arranged so that long axes thereof are aligned to be perpendicular to the display panels when an electric field is not applied to the liquid crystal layer is capable of implementing a high contrast ratio and a wide viewing angle. A method for implementing a wide viewing angle in the vertical alignment (VA) mode liquid crystal display includes a method of forming a domain forming member such as a gap or a protrusion in an electric field generating electrode provided in the display panels, etc.

A liquid crystal display with the domain forming member is divided into the vertical alignment (VA) mode liquid crystal display with domain forming members on both display panels and a patternless VA mode liquid crystal display having a minute pattern only on a lower substrate and no pattern on an upper substrate. A display region of the VA mode liquid crystal display is partitioned into a plurality of domains by the domain forming member and liquid crystal molecules within each domain are approximately inclined in the same direction. However, in an initial stage in which voltages are applied to both sides of the liquid crystal layer in a vertical alignment state, the inclination direction of the liquid crystal molecules is not immediately determined, resulting in disclination, and thereby causing a long time period for the liquid crystal layer to reach a stable state.

### SUMMARY OF THE INVENTION

The present invention provides a method of manufacturing a liquid crystal display that is capable of improving response speed.

Additional features of the invention will be set forth in the description which follows, and in part will be apparent from the description, or may be learned by practice of the invention.

The present invention discloses a method of manufacturing a liquid crystal display including forming a first display panel, forming a second display panel, disposing a liquid crystal mixture including a liquid crystal material and an alignment assistant material between the first display panel and the second display panel, the first display panel, the second display panel and the liquid crystal mixture forming a liquid crystal panel assembly, and curing of the alignment assistant material by applying ultrasonic waves to the liquid crystal panel assembly.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a layout diagram of a liquid crystal display manufactured by a method of manufacturing a liquid crystal display according to an exemplary embodiment of the present invention.

FIG. 2 is a cross-sectional view of a liquid crystal display taken along line B-B′ in FIG. 1.

FIG. 3, FIG. 4, FIG. 5, FIG. 6 and FIG. 7 are cross-sectional views sequentially illustrating a method of manufacturing a liquid crystal display according to an exemplary embodiment of the present invention.

FIG. 8 illustrates a W/B afterimage pattern.

FIG. 9 illustrates an afterimage level for each ultrasonic wave application period according to an exemplary embodiment of the present invention.

FIG. 10 illustrates a weight ratio of a remaining uncured UV curing monomer for each ultrasonic wave application period according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

The spatially relative terms “below”, “beneath”, “lower”, “above”, and “upper” may be used to easily describe a correlation between one element or constituent element and other elements or constituent elements as shown in the accompanying drawings. The spatially relative terms should be understood as terms including directions shown in the drawings in addition to different orientations of elements in use or operation.

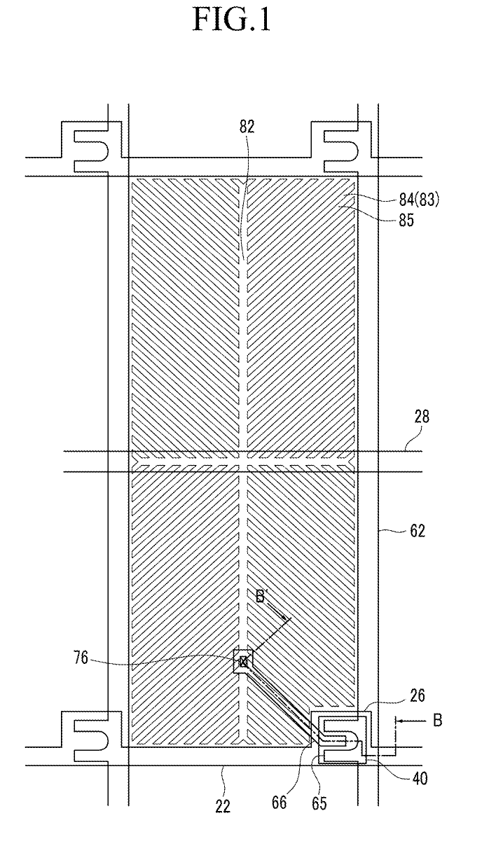

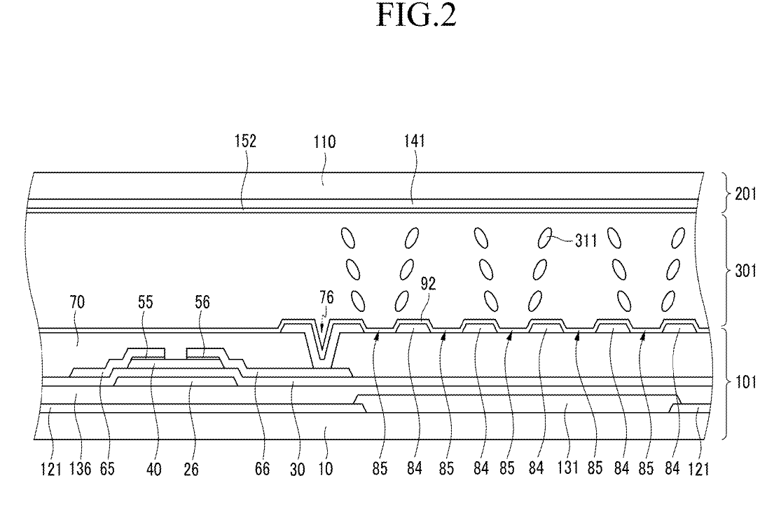

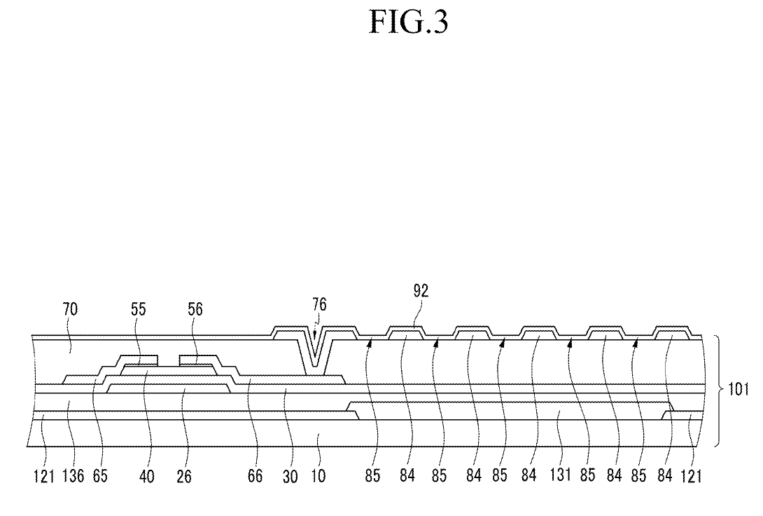

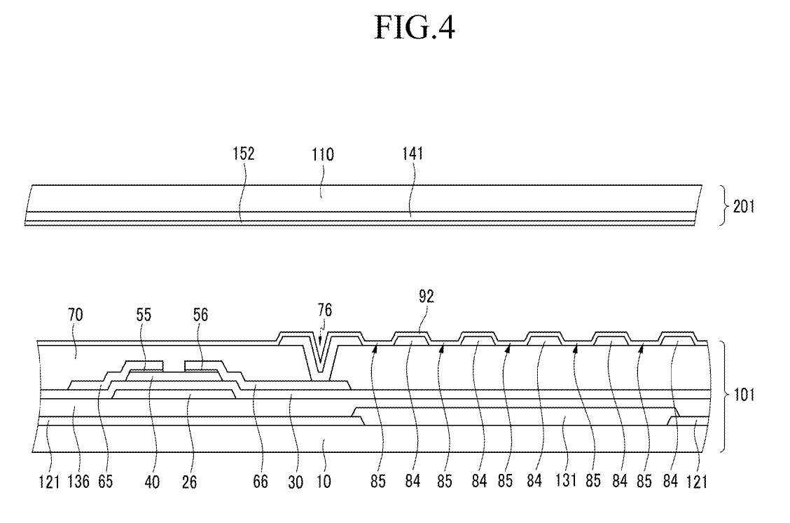

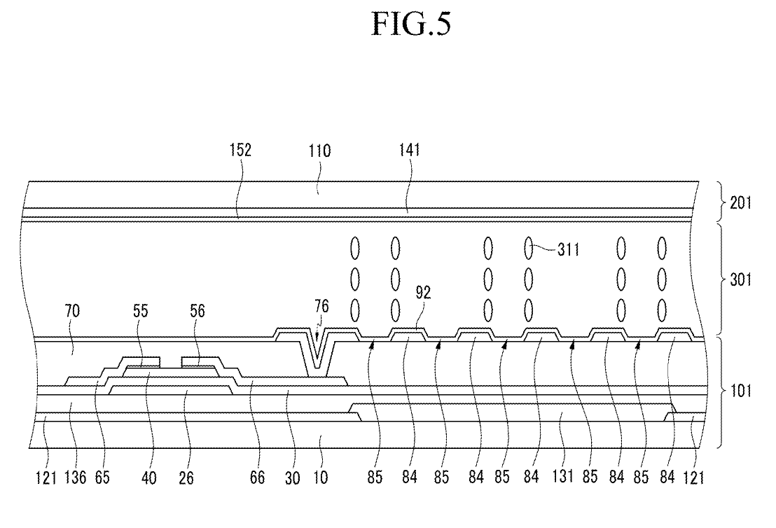

FIG. 1 is a layout diagram of a liquid crystal display manufactured by a method according to an exemplary embodiment of the present invention, FIG. 2 is a cross-sectional view of a liquid crystal display taken along line B-B′ in FIG. 1, and FIG. 3, FIG. 4, FIG. 5 and FIG. 6 are cross-sectional views sequentially illustrating a method of manufacturing a liquid crystal display according to another exemplary embodiment of the present invention.

Hereinafter, referring to FIG. 1, FIG. 2, FIG. 3, FIG. 4, FIG. 5 and FIG. 6, a liquid crystal display and a method of manufacturing the same according to an exemplary embodiment of the present invention will be described. The liquid crystal display manufactured by the manufacturing method according to an exemplary embodiment of the present invention may have an array on color filter (AOC) structure in which a thin film transistor array such as a gate wire or the like is formed on a color filter 131 or a color filter on array (COA) structure in which the color filter 131 is formed on the thin film transistor array, but the liquid crystal display having the AOC structure will be hereinafter described in detail.

Referring to FIG. 2, a liquid crystal display according to an exemplary embodiment of the present invention includes a liquid crystal panel assembly, a backlight assembly, and the like. The liquid crystal panel assembly includes a first display panel 101 and a second display panel 201 opposed thereto, a liquid crystal layer 301 interposed between the two display panels 101 and 201, a sealant (not shown) and a spacer (not shown) formed therebetween, and a polarizer (not shown) and the like attached to the first and second display panels 101 and 201. The liquid crystal layer 301 may be a vertically aligned layer.

As shown in FIG. 2, the first display panel 101 includes a black matrix 121, a color filter 131, a pixel electrode, and the like.

Specifically, the black matrix 121 is formed on an insulation substrate 10. The black matrix 121 may be formed by depositing an opaque material such as chromium, etc., through sputtering and the like, and patterning the deposited opaque material through photolithography processing.

The color filter 131 is formed on the black matrix 121 and the insulation substrate 10. The color filter 131 may be formed by applying a photosensitive resist to a front surface of the insulation substrate 10, and exposing and developing it.

An overcoat layer 136 having a flat surface is formed on the black matrix 121 and the color filter 131.

Referring to FIG. 1, gate wiring including a gate line 22, a gate electrode 26, and storage wiring 28 that extend in a horizontal direction are formed on the overcoat layer 136. A gate insulating layer 30 made of silicon nitride (SiNx), silicon oxide, or the like, a semiconductor layer 40 made of hydrogenated amorphous silicon, polysilicon, or the like, and ohmic contact layers 55 and 56 made of a material such as n+ hydrogenated amorphous silicon doped with n-type impurities at a high concentration, or silicide, are formed on the gate wiring.

Data wiring including a data line 62, a source electrode 65, and a drain electrode 66 that extends in a vertical direction, is formed on the ohmic contact layers 55 and 56 and the gate insulating layer 30. The source electrode 65, the drain electrode 66, and the gate line 22 form three terminals of a switching element. A part of the semiconductor layer 40 positioned between the source electrode 65 and the drain electrode 66 is exposed.

A passivation layer 70 made of an insulating material is formed on the data line 62, the drain electrode 66, and the exposed part of the semiconductor layer 40. A contact hole 76 for exposing the drain electrode 66 is formed in the passivation layer 70.

A pixel electrode is formed on the passivation layer 70 to be electrically connected to the drain electrode 66 through the contact hole 76. That is, the pixel electrode is physically and electrically connected to the drain electrode 66 through the contact hole 76 and receives a data voltage from the drain electrode 66.

The pixel electrode may be made of a transparent conductor such as indium tin oxide (ITO), indium zinc oxide (IZO), or the like. The pixel electrode may be partitioned into a plurality of domain regions by a domain forming member. Herein, a domain represents a region composed of liquid crystals collectively inclined in a specific direction on a planar surface by an electric field. The domain forming member may be a protrusion or a gap formed in the pixel electrode. A domain forming member 83 according to an exemplary embodiment of the present invention may be a cutting pattern formed by patterning the pixel electrode.

The pixel electrode according to an exemplary embodiment of the present invention may include a plurality of minute electrodes 84 having a plurality of minute slits 85. The pixel electrode may be formed by depositing a conductive material for the pixel electrode through sputtering and patterning the deposited conductive material through photolithography processing.

The pixel electrode shown in FIG. 1 includes a cross-shaped stem part 82 defining four quadrantal surfaces and a plurality of minute electrodes 84 extending from the stem part 82 in an oblique direction. The plurality of minute electrodes 84 positioned on the four quadrantal surfaces are parallel to each other and define the minute slits 85. The minute electrodes 84 may be inclined at approximately 45 degrees with respect to the stem part 82. In this case, the transmissive axis of the polarizer may be parallel to the stem parts 82. A maximum length of each minute electrode 84 is half the length of a horizontal length of the pixel electrode, in consideration of the response time of the liquid crystal layer 301. That is, the maximum length of each minute electrode 84 may be less than or equal to half the horizontal length of the stem part 82.

The width of the minute electrodes 84 may be constant or varied at a turning point and at an end point thereof. When the width of the minute electrodes 84 is constant, the widths of the minute electrodes 84 and the minute slits 85 may be the same or different from each other, and may be approximately 5 μm or less, for example. In a case where the width of the minute electrode 84 at the turning point is larger than that at the end point, liquid crystal molecules 311 may be not inclined in a predetermined direction and may be easily aligned in a direction parallel to the minute slit 85 when a vertical electric field is applied.

A first vertical alignment layer 92 for vertically aligning the liquid crystal layer 301 is formed on the pixel electrode and the passivation layer 70. In a case where the polarizer is a perpendicular polarizer, a black color is displayed on the liquid crystal display when a voltage is not applied to the liquid crystal layer 301. The first vertical alignment layer 92 may be made of a material including a polyimide backbone and a side chain. The first vertical alignment layer 92 may be formed by a printing method.

Referring to FIG. 4, the second display panel 201 is opposed to the first display panel 101 and includes a common electrode 141. The common electrode 141 may be formed by depositing the conductive material made of ITO or IZO on an insulation substrate 110 through sputtering. The common electrode 141 according to the present exemplary embodiment is not patterned and covers a front surface of the insulation substrate 110. When the common electrode 141 is not patterned as in the present exemplary embodiment of the present invention, a processing period is shortened, and misalignment between the first and second display panels 101 and 201 may be prevented, thereby suppressing a reduction of the transmittance of the liquid crystal display and reducing a defect rate.

A second vertical alignment layer 152 that is laminated by a printing method is formed on the common electrode 141.

The first display panel 101 and the second display panel 201 are joined to each other by the sealant. The spacer allows the two display panels 101 and 201 to be spaced apart from each other.

At the time of forming the sealant, an edge of the first display panel 101 or the second display panel 201 may be printed with the sealant, the second display panel 201 may be disposed to be opposed to the first display panel 101, and the first and second display panels 101 and 201 may be joined to each other by heat-treating or UV radiation-curing the sealant.

The liquid crystal layer 301 may be formed by using a vacuum injection method or a liquid crystal drip-injection method, and may further include polymers other than a liquid crystal material.

The liquid crystal layer 301 may be made by mixing the liquid crystal material with an alignment assistant material and injecting the mixture between the first display panel 100 and the second display panel 200. The liquid crystal material may have negative dielectric anisotropy, and may be a nematic liquid crystal, as an example. The alignment assistant material may include a reactive mesogen or a reactive monomer such as a UV curing monomer or a thermoplastic monomer. When the alignment assistant material includes the UV curing monomer, the alignment assistant material may further include a UV curing initiator. The UV curing monomer may be an acrylate monomer, for example. The UV curing initiator may be made of a material that absorbs light of a UV region, and may be 2,2-dimethoxy-1,2-diphenyl ethanone, for example. The UV curing initiator at more than 0 wt % and equal to or less than 0.05 wt % on the basis of the liquid crystal material and the UV curing monomer at more than 0 wt % and equal to or less than 1 wt % on the basis of the liquid crystal material may be included in the liquid crystal mixture.

In an exemplary embodiment of the present invention, a method of polymerizing the UV curing initiator and the UV curing monomer by mixing the UV curing initiator and the UV curing monomer with a liquid crystal material in a bulk state and curing the mixture on an interface between the first vertical alignment layer 92 and the second vertical alignment layer 152 is used, and two curing processes may be included.

First, referring to FIG. 6, in a first curing step, the UV curing monomer is cured by applying a pretilt voltage and radiating UV rays to the display panel assembly. The UV radiation may be applied just after a liquid crystal injection process.

In an exemplary embodiment of the present invention, as a step prior to the first curing step a process of preparing for the first display panel 101 and the second display panel 201 as unit substrates constituting one liquid crystal panel assembly and injecting the liquid crystal mixture therebetween is described. In a production line requiring mass production, the pixel electrode and the like are formed on a first mother substrate (not shown) that may be divided into a plurality of first display panels 101, the common electrode 140 and the like are formed on a second mother substrate (not shown) that may be divided into a plurality of second display panels 201, and then the liquid crystal mixture may be injected between the first mother substrate and the second mother substrate. In this case, in the first curing step, the UV curing monomer is cured by applying the pretilt voltage and radiating the UV rays to a layer of the liquid crystal mixture interposed between the first mother substrate and the second mother substrate.

A DC or AC voltage as the pretilt voltage may be applied to the liquid crystal mixture layer through a pad part for visual inspection of the first and second display panels 101 and 201, or through an additional pad part (not shown). The applied pretilt voltage may be a maximum gray voltage corresponding to a white state in a case of a normally black colored VA mode liquid crystal display. Further, the magnitude of the pretilt voltage is not fixed, and a voltage level of the pretilt voltage may gradually increase for a predetermined time. For example, the pretilt voltage may linearly increase at a predetermined slope over time, but the pretilt voltage may increase in various forms.

In the first curing step, the UV rays may be radiated to the outside surface of the first display panel 101 or the second display panel 201. However, since thin film structures that absorb and shield the UV rays, such as the color filter 131, the black matrix 121, and the like are disposed therein, it is preferable that the UV rays are radiated from the second display panel 201 to the first display panel 101.

In a state in which the pretilt voltage is applied, the liquid crystal molecules 311 are inclined in response to the electric field generated by the pretilt voltage, and the UV curing monomer is also arranged in the inclination direction of the liquid crystal molecules 311. In such a state, when the UV rays are radiated to the liquid crystal display, initial curing of the UV curing monomer is induced by the UV curing initiator at the interface between the first and second vertical alignment layers 92 and 152, and polymerization, that is, curing of the UV curing monomer arranged in a specific direction, is promoted. The magnitude of the pretilt voltage may be determined so that pretilt angles of the liquid crystal molecules 311 are generally in the range of 88 degrees to 89 degrees with respect to the first display panel 101.

However, even after the first curing step, the UV curing monomer may not be fully cured and some may remain in the liquid crystal mixture. The remaining monomer may be cured by applying an afterimage test pattern of white/black (W/B) to the liquid crystal display.

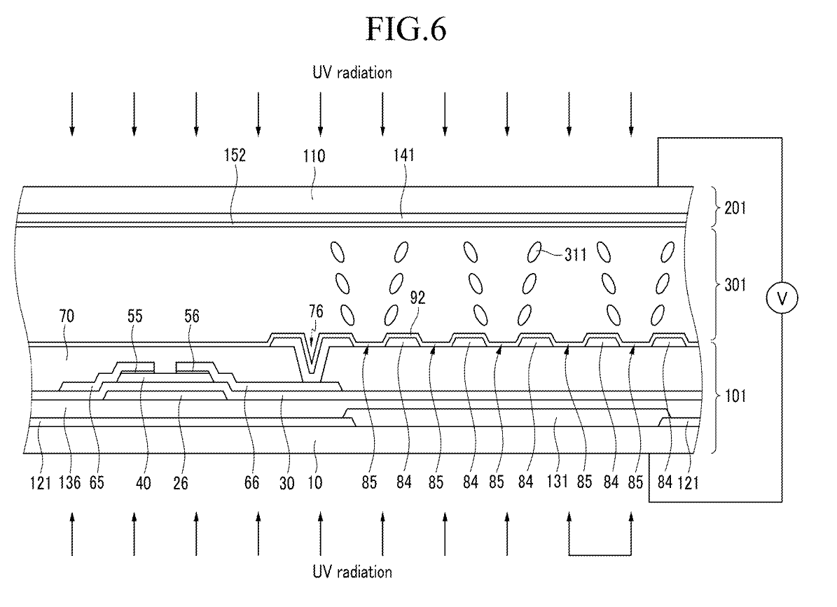

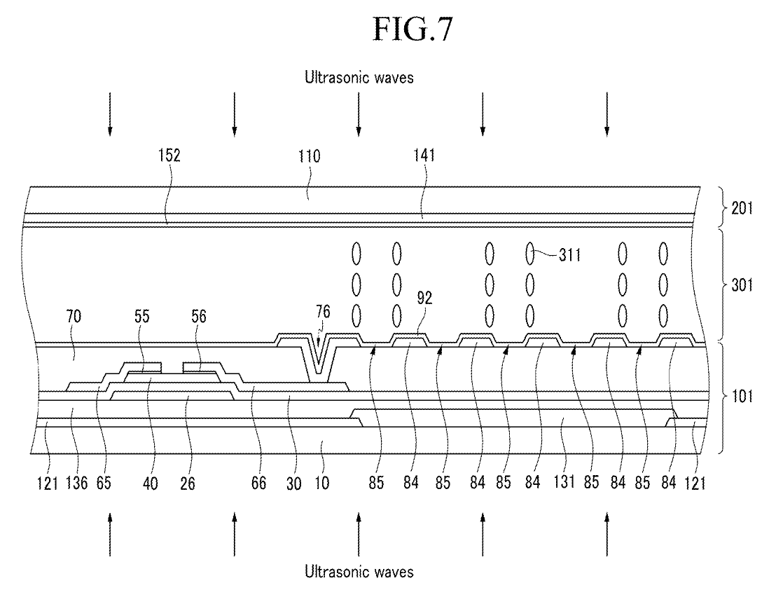

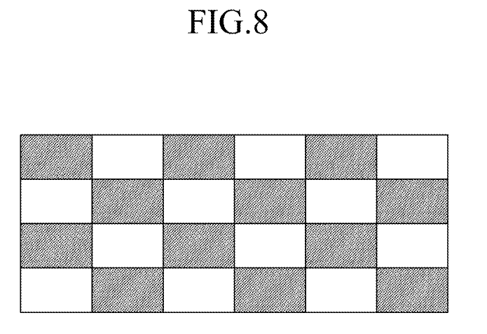

The W/B afterimage pattern may have a mosaic shape acquired by partitioning the liquid crystal display into a plurality of square regions and applying a white or black gray voltage to each square region as shown in FIG. 8. When a data voltage of a medium gray is applied to all pixels of the liquid crystal display after the W/B afterimage pattern is maintained for a long time, white and black colors of each region may be viewed without disappearing for a long time due to the delay of the liquid crystal response speed. While the W/B afterimage pattern is applied, a white region where the liquid crystal molecules 311 are aligned substantially parallel to the first display panel 101 and a black region where the liquid crystal molecules 311 are arranged in a direction substantially perpendicular to the first display panel 101 have different crystal alignment directions. Meanwhile, in this state, curing may progress for the remaining UV curing monomer. In this case, since the white region and the black region may have different liquid crystal alignment directions, monomer arrangement directions in the two regions may be different from each other and thus the pretilt angles of the liquid crystal molecules in the two regions may be different from each other, thereby increasing an afterimage display level. Therefore, uncured monomer remaining after the first curing step may be cured in order to resolve an afterimage error of the liquid crystal display.

An alternative second curing step may include heat treatment or UV radiation in a state in which the electric field is not applied to the liquid crystal display. Referring to FIG. 7, a second curing step according to an exemplary embodiment of the present invention may be an ultrasonic wave curing process of curing the remaining monomer by applying ultrasonic waves to the liquid crystal display in a state in which the voltage is not applied. The frequency of the ultrasonic waves used in the ultrasonic wave curing process may be in the range of 20 KHz or more. The ultrasonic waves generated in an ultrasonic wave generator are fully applied to the liquid crystal display via water used in a cleaning process of the liquid crystal display. In the ultrasonic wave curing process, it is possible to almost completely cure the remaining monomer. The ultrasonic wave curing process may be performed for a maximum of 6 hours before the first curing step is applied. When a state in which external force is not applied to the monomer under an activated curing reaction through the first curing step is maintained, the curing operation may be stopped by self-termination.

Next, an application step of the ultrasonic wave curing process will be described. A liquid crystal panel manufacturing process includes an attachment process of arranging and joining the first and second display panels 101 and 201 to each other with a sealant, and a liquid crystal injection process of interposing the liquid crystal mixture containing the alignment assistant material s between the first and second display panels 101 and 201 by using the vacuum injection as described above or a dripping process. Subsequently, a perpendicular or parallel polarizer should be disposed onto upper and lower surfaces. Prior to this, the liquid crystal panel manufacturing process may further include a cleaning process of the liquid crystal display panels for removing foreign substances from surfaces of the first and second display panels 101 and 201. In the display panel cleansing process, a plurality of cleansing units such as an eximer UV radiating unit, an alkali cleaning unit, an ultrasonic wave cleaning unit, and the like may be adopted, and an ionic material, a particulate material, and a film-like contamination material of the display panels 101 and 201 may be removed by successively passing the display panels 101 and 201 through the cleaning units. The ultrasonic wave curing process may be independently carried out, but in a case in which the ultrasonic wave curing process is progressed by utilizing the ultrasonic wave cleaning unit used in the display panel cleansing process, additional equipment investment is not required, thereby saving cost and shortening a process period.

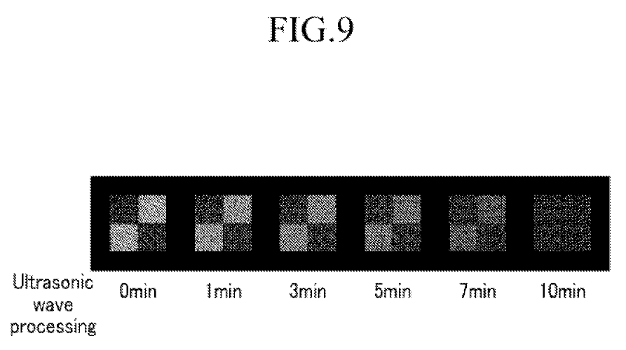

To verify an afterimage enhancement effect according to an exemplary embodiment of the present invention, the ultrasonic wave curing may be performed after the UV radiation curing has been performed for 60 minutes. When an ultrasonic wave curing period is varied in the range of 0 to 10 minutes, the afterimage level of the liquid crystal display is as shown in FIG. 9. In FIG. 9, it is possible to verify that the afterimage level is enhanced as the ultrasonic application period becomes longer.

In the following Table 1, an afterimage level for each ultrasonic wave curing period is shown, and an afterimage elimination voltage is measured and quantified. As the viewed afterimage level becomes stronger, the afterimage may be eliminated by increasing the voltage applied to the liquid crystal layer in the normally black colored VA mode liquid crystal display. The afterimage elimination voltage represents the voltage applied at this time. Accordingly, as the afterimage elimination voltage becomes lower, the afterimage level becomes lower. Like a result shown in FIG. 9, referring to Table 1, as the ultrasonic wave application period increases, the afterimage elimination voltage decreases, thereby reducing the afterimage.

TABLE 1

Ultrasonic wave
processing period
(min.)

| | 0 | 1 | 3 | 5 | 7 | 10 |
|---|---|---|---|---|---|---|
| Afterimage | 4.5 | 4.3 | 4.3 | 4.2 | 4.0 | 3.9 |
| elimination | | | | | | |
| voltage (V) | | | | | | |

In a mechanism for reducing the afterimage level by the application of the curing process, when a physical external force such as the ultrasonic waves and the like is applied to the UV curing monomer under the activated curing reaction state in the first curing step, the number of reaction collisions between the activated UV curing monomer and UV curing monomer adjacent thereto increases and thus a curing reaction probability increases, thereby decreasing the amount of remaining uncured UV curing monomer.

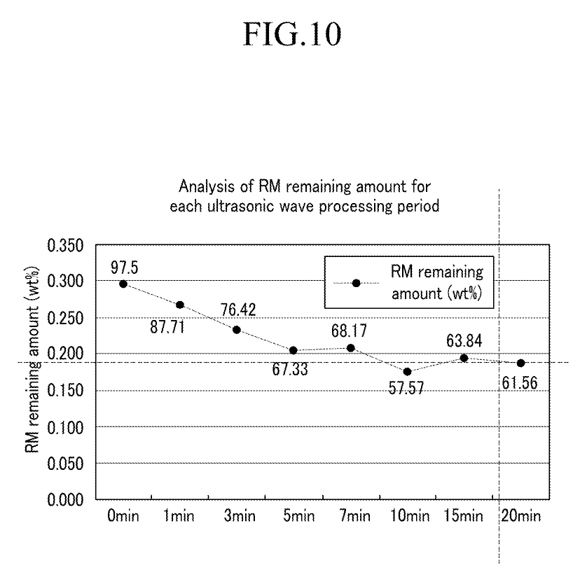

FIG. 10 illustrates a result of evaluating the amount of remaining UV curing monomer existing within the liquid crystal mixture as the ultrasonic wave curing process period increases as a weight ratio for the total amount of the UV curing monomer. In FIG. 10, it is verified that the weight ratio of the remaining UV curing monomer decreases as the ultrasonic wave application period increases. Accordingly, referring to FIG. 9, FIG. 10 and Table 1, it is verified that the decrease in the amount of the remaining UV curing monomer is in close relation to the enhancement of the afterimage level of the liquid crystal display.

According to another exemplary embodiment of the present invention, in the second curing step for reducing the remaining UV curing monomer, heat treatment or UV radiation may be applied in addition to the ultrasonic wave curing process in a state in which the voltage is not applied to the liquid crystal display. In this case, it is possible to further reduce the remaining UV curing monomer in comparison with the application of only the one process.

After the ultrasonic wave curing step, one polarizer may be disposed on a surface opposite to each of the first and second display panels 101 and 201 with a plurality of elements. A transmissive axis for transmitting only polarized light of a specific direction exists in the polarizer. The polarization axes of the polarizers may be perpendicular or parallel to each other. Subsequently, the liquid crystal display is completed by disposing a backlight assembly including a lamp on a side surface or a lower part of the liquid crystal display.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method of manufacturing a liquid crystal display, comprising:
forming a first display panel;
forming a second display panel;
disposing a liquid crystal mixture comprising a liquid crystal material and an alignment assistant material between the first display panel and the second display panel, the first display panel, the second display panel, and the liquid crystal mixture forming a liquid crystal panel assembly; and
curing the alignment assistant material by applying ultrasonic waves to the liquid crystal panel assembly.

2. The method of claim 1, wherein the alignment assistant material comprises one of a reactive mesogen, a UV curing monomer and a UV curing initiator.

3. The method of claim 1, further comprising: curing the alignment assistant material through heat treatment or UV radiation.

4. The method of claim 3, wherein UV rays are radiated from the first display panel to the second display panel in the UV radiation.

5. The method of claim 3, wherein curing the alignment assistant material through heat treatment or UV radiation comprises applying a pretilt voltage to the liquid crystal panel assembly.

6. The method of claim 5, wherein the pretilt voltage is the maximum gray voltage.

7. The method of claim 5, wherein a voltage level of the pretilt voltage increases over time.

8. The method of claim 3, wherein curing the alignment assistant material by applying ultrasonic waves to the liquid crystal panel assembly is performed after curing the alignment assistant material through heat treatment or UV radiation.

9. The method of claim 8, wherein curing the alignment assistant material by applying ultrasonic waves to the liquid crystal panel assembly is performed 6 hours after curing the alignment assistant material through heat treatment or UV radiation.

10. The method of claim 8, wherein curing the alignment assistant material by applying ultrasonic waves to the liquid crystal panel assembly comprises applying ultrasonic waves having a frequency of 20 kHz or more in a state in which a voltage is not applied to the liquid crystal panel assembly.

11. The method of claim 1, wherein forming the first display panel comprises:
forming a gate line and a data line electrically insulated therefrom and crossing each other; and
forming a pixel electrode comprising a minute electrode comprising a domain forming member for dividing the liquid crystal material into a plurality of domains.

12. The method of claim 11, wherein the domain forming member is a protrusion or a gap.

13. The method of claim 11, wherein forming the first display panel further comprises:
depositing a color filter layer to correspond to a pixel electrode; and
patterning the color filter layer through a photolithography process.

14. The method of claim 11, wherein forming the first display panel further comprises laminating a black matrix and patterning the black matrix through a photolithography process.

15. The method of claim 14, further comprising:
curing the alignment assistant material through UV radiation before curing the alignment assistant material by applying ultrasonic waves to the liquid crystal panel assembly,
wherein curing the alignment assistant material through UV radiation comprises irradiating UV rays from the second display panel to the first display panel.

16. The method of claim 1, wherein curing the alignment assistant material by applying ultrasonic waves to the liquid crystal panel assembly comprises cleansing the liquid crystal panel assembly.
